(19) United States
(12) Patent Application Publication
(10) Pub. No.: US 2002/0162106 A1
(43) Pub. Date: Oct. 31, 2002

(54) Method and system for information insertion

(76) Inventors: Clifford Alan Pickover, Yorktown Heights, NY (US); Stephen J. Boies, Mahopak, NY (US); William Grey, Millwood, NY (US); Paul Andrew Moskowitz, Yorktown Heights, NY (US)

Correspondence Address: George Sai-Halasz, 145 Fernwood Dr., Greenwich, RI, 02818, US

(21) Appl. No.: 09/845,930

(22) Filed: Apr. 30, 2001

(51) Int. Cl. H04N 5/445; H04N 7/025; H04N 7/10

(52) U.S. Cl. 725/42; 725/34; 725/46

(57) ABSTRACT

A method and a computer program article of manufacture are disclosed for presenting an informational message to a client. This presentation occurs during a break of a media stream content. The break in the media content may be initiated by the client. This action of the client is detected and an appropriate informational message, including advertising is inserted into the media stream. An additional method is based on collecting revenues from advertisers for inserting their messages in the breaks of the media content stream.

### FIELD OF THE INVENTION

The present invention relates to the general area of providing informational messages, including advertising, to a client who is paying attention to a stream of media content. More specifically, the invention teaches the placing of the desired information into the breaks of the media content, when such breaks are associated with some action of the client.

### BACKGROUND OF THE INVENTION

Advertising is everywhere; its presence is virtually pervasive. Clearly, advertising fulfills important economical and social needs. People are looking for entertainment and information through a variety of media outlets and are ready, at the same time, to be exposed to informational, including advertising, messages.

There are many inventions already in this fertile field. For example, U.S. Pat. No. 5,948,061 to Merriman et al., incorporated herein by reference, teaches the targeting of advertisements to various intended audiences. The US patent application, “Method, System and Business Method for Providing Advertisements on Telephony Devices,” by Paul Moskowitz et al, filed Sep. 12, 2000, Ser. No. 09/660462, incorporated herein by reference, teaches advertising by mobile telephones. The US patent application, “Method and System for Advertising with Public Articles,” by Clifford Pickover et al, Ser. No. 09/795,881, filed Feb. 28, 2001, incorporated herein by reference, teaches advertising by using public domain articles.

However, there are still many places free of advertising material and awaiting for an opportunity. At the same time, advertisers find it challenging to know how, when, and where to effectively communicate or place advertisements in a variety of multimedia settings. The present invention teaches the automatic placement of advertisements at breakpoints that are convenient and associated with user actions. In particular, the invention necessitates that advertisements, or, in general, informational messages, automatically be inserted when a user, or client, (the two expressions are used interchangeably) interrupts the normal flow of the content of an information stream. In this invention for the concept of—content of an information stream—we use the shortened expression of—media content—. Depending on the particular embodiment, such interruptions include, for instance, changing a broadcast channel on television or radio. In another embodiment, a client changing a web page while browsing the Internet is such an interruption. In yet another embodiment, a client changing media, e.g. when a CD, DVD, disk, memory stick, tape, MP3, or other multimedia medium is removed, changed, or inserted, is a suitable interruption for inserting advertisement. In a further embodiment a client changing a song, chapter, act, etc. on a multimedia player or e-Book is an appropriate break in the flow of the media content.

A further advantage of the invention is that a break in the media content is a very opportune instance to expose the client to information, including advertisement. When a user, or client, interrupts the normal flow of the content of the presently streaming information, he or she is likely to be receptive to novel, unexpected, or additional information. It is safe to assume that the fact of the interruption by itself is an indication that the client is ready for something new or more amenable to receiving information than when the client is engaged in the middle of a media or other information stream.

### SUMMARY OF THE INVENTION

The object of the present invention is a method and a computer program article of manufacture that accomplishes the introduction of information, including advertising, into various media when there is a break in the flow of the media content, and when the break was caused by the user, or client.

In one embodiment the invention is used for advertising. The term “advertising”, as usual, means promotional material for goods and services. But the material inserted into the breaks can have broader reach. The subject can be any informational or artistic material including artwork, information, instructions, manuals, warning messages, suggestions, explanatory text, pleasing music, maps, or links to such material. The inserted material may also include bar codes or other codes that may control devices to be used by other devices. Various codes, visual or invisible, may be embedded in the source that can be used to provide additional information, or control devices that provide additional visual audio, tactile, textual, or aroma output. The inserted material in a further embodiment can be an announcement type message. Such a case would be a communication from authorities, for instance, to change the clock for daylight savings time or a reminder that smoking is unhealthy.

Details to accomplish the supplying of informational messages into media content breaks, depends on the media, and the particular embodiment. Typically one may have a buffer, or storage element, or storage media, containing a supply of informational messages. This buffer may reside in a smart set top box in the case of television, radio, or various players, like a tape player. In the case of broadcasts, as in radio, or television including cable television, the equipment upon sensing a break caused by user, may temporarily block the incoming media content and insert the informational message. The equipment while blocking the media content to the user, might buffer it as well, so the user would not loose out on any of the broadcast material. Blocking may cause a delay of the broadcast material, or the informational message may be superimposed on the broadcast material. Many clients will not mind a short segment of informational material that delays the onset of the new stream of broadcast material, even if it means that the client misses some of the new stream of broadcast material. In case of a stand alone compact disk, video player, digital video disk player, tape player, or other multimedia a storage element, or medium could keep a large number of informational messages, one of which at the right moment can be released. The stored informational messages may be regularly refreshed, for example, new informational messages may be periodically downloaded over a network. In the case of “web surfing,” the break caused by the client means the loading of a new web page or other multimedia content. In this particular case, the informational message again can come from a buffer locally on the device that contains the browser. Or alternatively, the informational material or buffer could be supplied by the Internet Service Provider. In the latter case, there may or may not be a storage element with informational messages on the server machine of the Internet Service Provider.

The choice of advertising content to be inserted into the break may depend on various parameters. The advertisement may depend on the nature and content of the previous and forthcoming media stream content. In other words, those media contents that bracket the break caused by the user may affect the advertising or informational content. For example, if a client is changing between two music broadcasts, e.g. MTV and VH1 on TV, the advertisement content may relate to music. The nature of the previous and forthcoming media content may be determined in many ways; for example, a system can analyze video and audio content of the media by scanning for certain words or images. An information table may associate broadcast sources (e.g. MTV) with a certain class of ads, which may be tagged with data that causes them to be presented when a client changes between one media stream and another. Similarly, rules may be used to determine which of a plurality of informational messages is presented to a client. For example, “if previous channel is MTV and forthcoming channel is PBS, display advertisements relating to classical music.”

The system may act in choosing an advertisement based on the last media content monitored just before the break. Alternatively, the content of various past selections may be monitored and acted upon in selecting advertising content. In yet another embodiment the system may be proactive and accept input from the client. For example, if the user selects the “change channel” button on a remote TV control, the TV may ask, “Would you like to hear an ad on cars?” or “Press 1 for an ad on cars; press 2 for an ad on books.”Each of the above choices would be facilitated by an intelligent agent as being part of the system. In the absence of any other guidance, with or without the involvement of an intelligent agent, the advertisement to be presented may be determined by the queuing sequence of advertisements in the storage element.

Advertisers may find this invention of particular interest. One often recruits advertisers interested to place their advertisements in front of clients. Having the capability to place the information, including advertisements, in the media content breaks allows the delivery of the advertisers message. In addition, the ads may be relevant to a user's interests in embodiments in which the ads relate to the nature of the previous or forthcoming media content. Payment received from the advertisers would depend on particular arrangements; typically they would pay in proportion to the number of advertisements placed. It is advantageous in most cases to collaborate with the provider of the media stream, if the media is such that a provider is involved, such as a TV cable supplier. The supplier could, among other things, regularly refresh the informational messages in the storage elements. The collaboration with such a supplier would typically be a simple monetary payment for the service the supplier provides.

### BRIEF DESCRIPTION OF THE DRAWINGS

These and other features of the present invention will become apparent from the accompanying detailed description and drawings.

FIG. 1. Schematically shows the general method of the invention.

FIG. 2. Schematically shows a general embodiment of the invention.

### DETAILED DESCRIPTION OF THE INVENTION

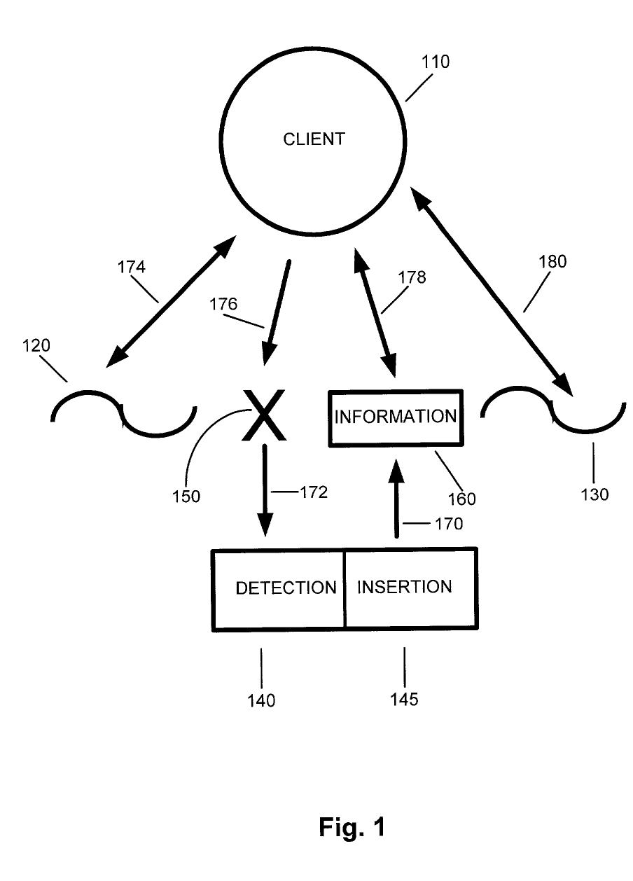

The view on FIG. 1 shows schematically a general embodiment of the invention. The client 110 is interacting 174 with the streaming media content 120. The interaction 174 is bidirectional. The client 110 is viewing, listening to, or in case of a game, playing with, the media content. This is the direction of arrow 174 from the media content 120 toward the client 110. The other direction of 174 toward the media content represents the ability of the client to cause or introduce an interruption 150 into the media content. This action 176, depending on the media content in different embodiments, can be the switching of a TV or radio channel, loading of a web page, changing a CD, or changing a song on a CD, changing a book or chapter in an e-Book, switching to a different part of a computer game, etc. The interruption 150 by the client is signaled 172 toward a first device, a detection unit 140. Depending on the particular embodiment this detection can occur in a TV, or radio set top box, or in the server machine of an Internet service provider, or by proper instrument plug-in in a multimedia equipment, etc. The detection by the interruption by the first device 140, is followed by an engagement of a second device 145, which engagement results in the insertion 170 of an informational message 160, typically an advertisement. The first device doing the detection and the second device doing the insertion in the figure is shown next to each other. This is however only a conceptual drawing, they can be physically co-located in a single unit. In some embodiment they may have shared subunits. This is a preferred embodiment, but other embodiments are possible. The two units do not have to cohabit a single physical unit, in some embodiments involving networks they could be found attached to different computing units, physically far from one another. The informational message is exposed 178 to the client 110. In the embodiment of a proactive system, the interaction 178 with the informational material is bidirectional, and input from the client is sought in the selection of advertising material. After an appropriate amount of time, the media content continues 130. This now is the content selected by the client to follow the interrupted one 120. In a special case, 120 and 130 may actually be the same, with the client continuing after the break with the earlier content, instead of switching to a new one. With the after-the-break content 130, the client interacts 180 also bidirectionally just as it has with the earlier content 120 through 174. If needed the whole process can start over, with 130 now being interrupted by the client.

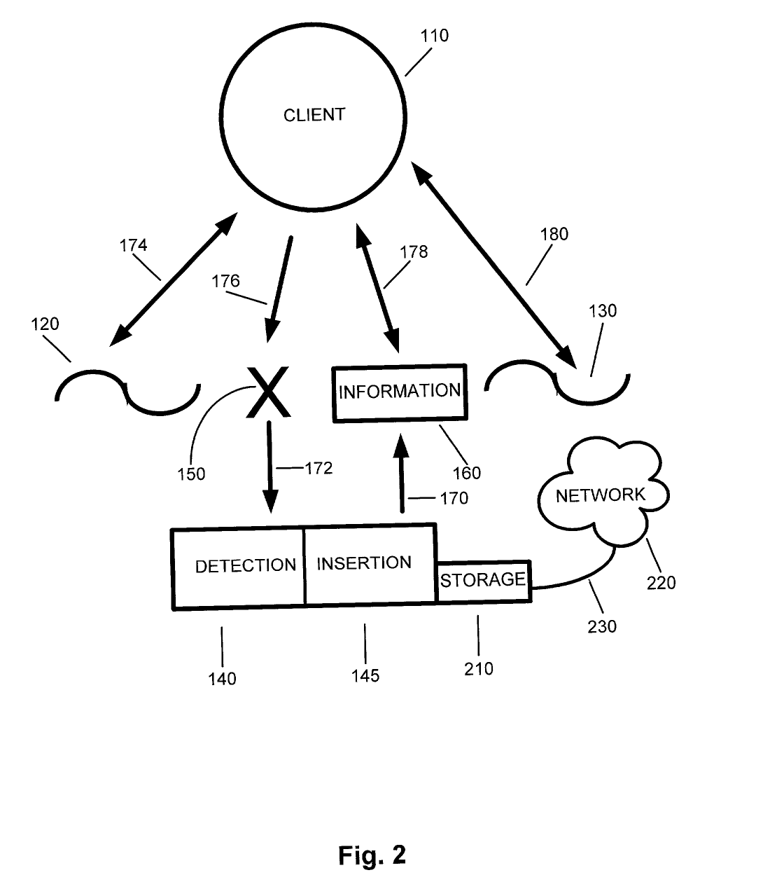

FIG. 2 shows the same invention with the addition of a storage element 210 and a network 220. The informational material is stored in a storage medium 210, likely as part of the insertion unit. The informational material is at times refreshed. There are many ways to accomplish this task, such as physically inserting a disk, or other memory device. In a preferred embodiment the refreshment occurs through a network 220 and an appropriate connection 230. The network can be a local area network, a piconet, or a wireless network. In an additional embodiment the network can be the Internet.

Many modifications and variations of the present invention are possible in light of the above teachings, and could be apparent for those skilled in the art. The scope of the invention is defined by the appended claims.

We claim:

1. A method for presenting an information to a client, wherein the client is interacting with a media content, comprising the steps of:
detecting an action by the client, wherein the action is causing a break in the media content; and
inserting the information into the break of the media content.

2. The method of claim 1, wherein the information is an advertisement.

3. The method of claim 1, wherein the information is an announcement.

4. The method of claim 1, wherein the action by the client comprises the step of changing a broadcast channel.

5. The method of claim 4, wherein the broadcast channel is a television channel.

6. The method of claim 4, wherein the broadcast channel is a radio station.

7. The method of claim 1, wherein the action by the client comprises the step of changing a cable television channel.

8. The method of claim 1, wherein the action by the client comprises the step of loading a web page.

9. The method of claim 1, wherein the action by the client comprises the step of controlling a media player.

10. The method of claim 9, wherein the media player is a compact disk player.

11. The method of claim 9, wherein the media player is a audio tape player.

12. The method of claim 9, wherein the media player is a video player.

13. The method of claim 9, wherein the media player is a multimedia player.

14. The method of claim 2, wherein a choice of the advertisement is facilitated by an intelligent agent.

15. The method of claim 14, wherein the intelligent agent accepts an input from the client.

16. The method of claim 14, wherein the choice of the advertisement is determined by characteristics of the media contents bracketing the action by the client.

17. The method of claim 14, wherein the choice of the advertisement is determined by characteristics of the media content immediately preceding the action by the client.

18. The method of claim 14, wherein the choice of the advertisement is determined by characteristics of several of the media contents preceding the action by the client.

19. The method of claim 2, further comprising the step of storing one or more advertisements.

20. The method of claim 19, wherein a choice of the advertisement is determined by a queuing sequence of the one or more stored advertisements.

21. The method of claim 19, further comprising the step of refreshing the one or more stored advertisements.

22. The method of claim 21, wherein the step of refreshing the one or more stored advertisements transpires over a network.

23. The method of claim 22, wherein the network is the Internet.

24. A computer data signal embodied in a carrier wave encoding a computer program of instructions for executing a computer process performing the steps for presenting an information to a client, as recited in the steps of claim 1.

25. A system for presenting an information to a client, wherein the client is interacting with a media content, comprising:
a first device adapted for detecting a break in the media content, wherein the break is caused by an action of the client; and
a second device adapted for inserting the information into the break of the media content.

26. The system of claim 25, wherein the first device and the second device are co-located in a single physical unit.

27. The system of claim 25, wherein the information is an advertisement.

28. The system of claim 25, wherein the information is an announcement.

29. The system of claim 27, wherein the media content is transmitted over a television channel.

30. The system of claim 27, wherein the media content is transmitted over a radio channel.

31. The system of claim 27, wherein the second device is further adapted to accept advertisements for insertion from a storage medium.

32. The system of claim 31, wherein the storage medium accepts a refreshment of the advertisements.

33. The system of claim 32, wherein the refreshment of the advertisements is executed over a network.

34. The system of claim 33, wherein the network is the Internet.

35. A method for collecting revenues from one or more advertisers, comprising the steps of:
developing a capability for inserting an advertisement into a break in a media content, wherein the break being caused by a client interacting with the media content; and
collecting revenues from the one or more advertisers for having exposed the client to the advertisement.

36. The method of claim 35, wherein the step of developing the capability further comprises the step of collaborating with a supplier, wherein the supplier delivers the media content to the client.

37. The method of claim 36, wherein the step of collaborating comprises a monetary payment to the supplier.
